(19) United States
(12) Patent Application Publication
(10) Pub. No.: US 2009/0162263 A1
(43) Pub. Date: Jun. 25, 2009

(54) ATMOSPHERIC-PRESSURE PLASMA REACTOR

(75) Inventors: CHIA-CHIANG CHANG, Taipei County (TW); JIN-CHING WU, Hsinchu City (TW); CHIH-WEI CHEN, Taipei County (TW); WEN-TUNG HSU, Yunlin County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/123,559

(22) Filed: May 20, 2008

(30) Foreign Application Priority Data
Dec. 21, 2007 (TW) 096149155
May 8, 2008 (TW) 097116933

(51) Int. Cl. H05H 1/24

(52) U.S. Cl. 422/186.04

(57) ABSTRACT

An atmospheric-pressure plasma reactor comprising a first electrode, a second electrode and a power generation unit. The first electrode and the second electrode respectively have a first opening and a second opening corresponding to each other. Disposed inside the first electrode is a gas-in space, which communicates with the first opening. Moreover, the power generation unit is coupled to the first electrode to provide the first electrode with AC power. The second electrode is grounded. The plasma process by the atmospheric-pressure plasma reactor is capable of forming high-uniformity thin film on a substrate.

### BACKGROUND OF THE INVENTION

1. Field of the Invention

The present invention generally relates to a plasma reactor and, more particularly, to an atmospheric-pressure plasma reactor.

2. Description of the Prior Art

The plasma related technologies have been widely used in industries such as semiconductor IC manufacturing, wherein plasma is used in thin film growth and/or etching. Generally, plasma reactors can be categorized into vacuum plasma reactors and atmospheric-pressure plasma reactors. Nowadays, the technology for vacuum plasma reactors is much better developed. However, vacuum plasma reactors require expensive vacuum equipments, which leads to high cost for vacuum plasma processing.

Even though atmospheric-pressure plasma reactors are advantageous in low processing cost, the film quality by an atmospheric-pressure plasma reactor still lags behind that by a vacuum plasma reactor. The conventional atmospheric-pressure plasma reactor often results in films with poor uniformity, poor roughness, poor adhesion and poor hardness. Therefore, it is a key issue to improve the atmospheric-pressure plasma reactor to overcome the problems related to poor film quality.

FIG. 1 is a schematic diagram of a conventional atmospheric-pressure plasma reactor. Referring to FIG. 1, the conventional atmospheric-pressure plasma reactor 100 comprises a power electrode 110, a grounded electrode 120, a dielectric plate 130 and a power generation unit 140. The dielectric plate 130 is disposed on the power electrode 110 to separate the power electrode 110 and the grounded electrode 120. The power generation unit 140 is capable of providing the power electrode 110 with low-frequency high-voltage AC power, while the grounded electrode 120 is grounded.

A silicon substrate 150 is disposed on the grounded electrode 120 and corresponds to the power electrode 110. Helium 162 is introduced between the power electrode 110 and the grounded electrode 120 from the left side of the atmospheric-pressure plasma reactor 100 so as to generate a plasma source 164 to perform etching or film growth on the silicon substrate 150. Moreover, the residual helium 166 that does not participate in forming the plasma source 164 is exhausted from the right side of the atmospheric-pressure plasma reactor 100.

By using the structural design of the atmospheric-pressure plasma reactor 100, the power generation unit 140 provides AC power with a voltage within the range from 5000 to 20000 volts and a frequency lower than 100 KHz so that helium 162 can be ionized to form the plasma source 164. The AC frequency lower than 100 KHz results in low density of the plasma source 164. Therefore, a voltage over 5000 volts is required. However, such a high voltage causes dangers to the atmospheric-pressure plasma reactor 100 and damages to the power electrode 110.

Furthermore, since the space between the silicon substrate 150 and the dielectric plate 130 is so long and narrow that it is hard for helium 162 to spread uniformly, which causes the generated plasma source 164 to exhibit poor density uniformity. As a result, the roughness of the thin film is poor and the surface after etching is rough, which leads to poor film quality.

FIG. 2A is a schematic diagram of another conventional atmospheric-pressure plasma reactor, and FIG. 2B is a schematic diagram showing the process of the atmospheric-pressure plasma reactor in FIG. 2A. Referring to FIG. 2A and FIG. 2B, the conventional atmospheric-pressure plasma reactor 200 comprises a power electrode 210, a grounded electrode 220 and a power generation unit 230. Disposed inside the grounded electrode 220 are a gas-in space S1, a plasma generation space S2 and a plasma exhaustion space S3. Part of the power electrode 210 is disposed in the plasma generation space S2. Moreover, the power generation unit 230 is capable of providing the power electrode 210 with AC power, while the grounded electrode 220 is grounded.

After helium 242 enters the plasma generation space S2 from the gas-in space S1, it is ionized into a plasma source 244 by the change of electric field between the power electrode 210 and the grounded electrode 220. The plasma source 244 moves towards the plasma exhaustion space S3 and then is injected by a nozzle 222 to perform the plasma process. Furthermore, before the plasma source 244 is injected by the nozzle 222, reactive gas (or referred to as precursor gas) 246 such as a siloxane compound comprising tetraethoxysilane (TEOS), tetramethylcyclotetrasiloxane (TMCTS), tetramethyldisiloxane (TMDSO), hexamethyldisiloxane (HMDSO), hexamethyldisilazane (HMDSN) can be added to the plasma source 244 for a variety of plasma processes.

However, the atmospheric-pressure plasma reactor 200 requires a high voltage so that the density of the plasma source 244 is sufficient for the plasma process, which causes hazards. Moreover, since the plasma process is performed by the atmospheric-pressure plasma reactor 200 in a single region, considerable process time is required to move the substrate (not shown) so as to complete the plasma process such as etching or film growth all over the substrate. Therefore, the atmospheric-pressure plasma reactor 200 exhibits low throughput and cannot be used in plasma processes on a large-area substrate. Furthermore, the atmospheric-pressure plasma reactor 200 has a problem of non-uniformity of grown films.

### SUMMARY OF THE INVENTION

The present invention provides an atmospheric-pressure plasma reactor capable of forming high-uniformity thin film with a lowered voltage for the plasma process to enhance the overall security.

In order to achieve the foregoing or other objects, the present invention provides an atmospheric-pressure plasma reactor comprising a first electrode, a second electrode and a power generation unit. The first electrode and the second electrode respectively have a first opening and a second opening corresponding to each other. Disposed inside the first electrode is a gas-in space, which communicates with the first opening. Moreover, the power generation unit is coupled to the first electrode to provide the first electrode with AC power, while the second electrode is grounded.

In one embodiment of the present invention, the first opening comprises a plurality of first holes, and the second opening comprises a plurality of second holes corresponding to the first holes respectively. Moreover, the diameter of the second holes is larger than that of the corresponding first holes respectively.

In one embodiment of the present invention, the first opening comprises a plurality of first holes, and the second opening comprises a second slot corresponding to the first holes. The second slot is a slit-shaped slot. Moreover, the width of the second slot is larger than the diameter of the first holes.

In one embodiment of the present invention, the first opening comprises a first slot, and the second opening comprises a second slot corresponding to the first slot. The second slot is a slit-shaped slot. Moreover, the width of the second slot is larger than that of the first slot, and the length of the second slot is larger than that of the first slot.

In one embodiment of the present invention, the frequency of the AC power is within a range from 100 KHz to 100 MHz. More particularly, the AC power is radio-frequency (RF) power.

In one embodiment of the present invention, the atmospheric-pressure plasma reactor further comprises a casing connected to the second electrode to form a containment space, wherein the first electrode is disposed inside the containment space and the casing comprises a third opening communicating with the containment space.

In one embodiment of the present invention, the atmospheric-pressure plasma reactor further comprises a plasma gas, entering the containment space through the third opening to generate a first plasma source between the first electrode and the second electrode. Moreover, the plasma gas comprises helium, oxygen, nitrogen, argon or combination thereof.

In one embodiment of the present invention, the atmospheric-pressure plasma reactor further comprises a reactive gas, passing through the first opening from the gas-in space to react with the first plasma source to generate a second plasma source that passes through the second opening. Moreover, the reactive gas comprises a siloxane compound (such as tetraethoxysilane (TEOS), tetramethylcyclotetrasiloxane (TMCTS), tetramethyldisiloxane (TMDSO), hexamethyldisiloxane (HMDSO) or hexamethyldisilazane (HMDSN)). Furthermore, the reactive gas comprises helium, oxygen, argon, carbon fluoride or combination thereof.

In one embodiment of the present invention, the atmospheric-pressure plasma reactor further comprises a diffusing plate disposed inside the containment space, the diffusing plate comprising a plurality of diffusing holes. Moreover, first electrode comprises a metal conductor such as copper alloy, aluminum alloy, or stainless steel. The second electrode comprises a metal conductor such as copper alloy, aluminum alloy, or stainless steel. The casing and the second electrode are formed as one.

Accordingly, in the atmospheric-pressure plasma reactor of the present invention, a uniform first plasma source is first formed between the first electrode and the second electrode, and a second plasma source is then formed by introducing the reactive gas through the first opening to react with the first plasma source. The formed second plasma source passes through the second opening to perform the plasma process and form a high-uniformity thin film on the substrate. Moreover, in the present invention, the voltage of the AC power is reduced to 200 to 300 volts for the plasma process so as to enhance the overall security of the atmospheric-pressure plasma reactor.

### BRIEF DESCRIPTION OF THE DRAWINGS

The objects, spirits and advantages of the several embodiments of the present invention will be readily understood by the accompanying drawings and detailed descriptions, wherein:

FIG. 1 is a schematic diagram of a conventional atmospheric-pressure plasma reactor;

FIG. 2A is a schematic diagram of another conventional atmospheric-pressure plasma reactor;

FIG. 2B is a schematic diagram showing the process of the atmospheric-pressure plasma reactor in FIG. 2A;

FIG. 3A is a cross-sectional view of an atmospheric-pressure plasma reactor according to one embodiment of the present invention;

FIG. 3B and FIG. 3C are cross-sectional view showing the process of the atmospheric-pressure plasma reactor in FIG. 3A;

FIG. 4A and FIG. 4B are top views of a first electrode and a second electrode of the atmospheric-pressure plasma reactor in FIG. 3A, respectively;

FIG. 5A and FIG. 5B are top views of a first electrode and a second electrode of an atmospheric-pressure plasma reactor according to another embodiment of the present invention, respectively; and

FIG. 6A and FIG. 6B are SEM pictures showing silicon dioxide thin films formed by a conventional atmospheric-pressure plasma reactor and an atmospheric-pressure plasma reactor of the present invention, respectively.

### DETAILED DESCRIPTION OF THE PREFERRED EMBODIMENT

The present invention can be exemplified by but not limited to the embodiments as described hereinafter.

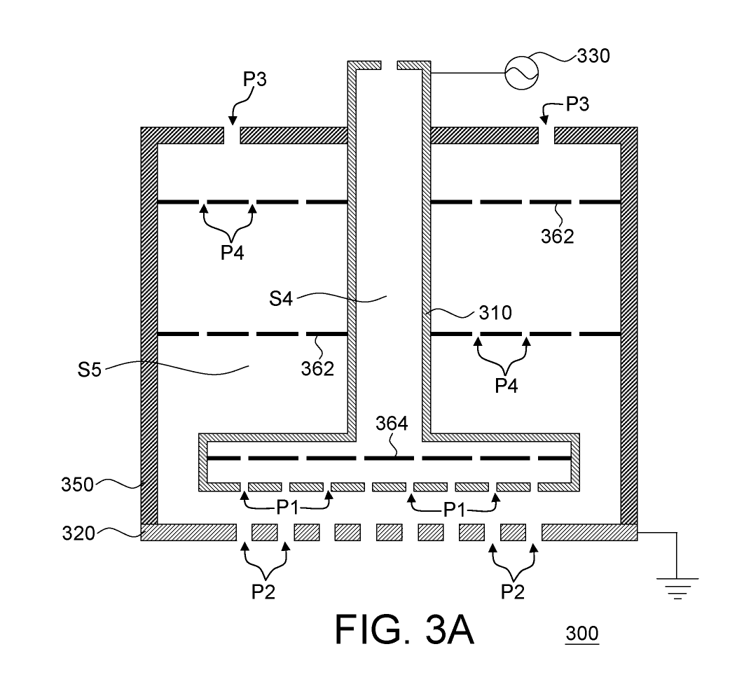

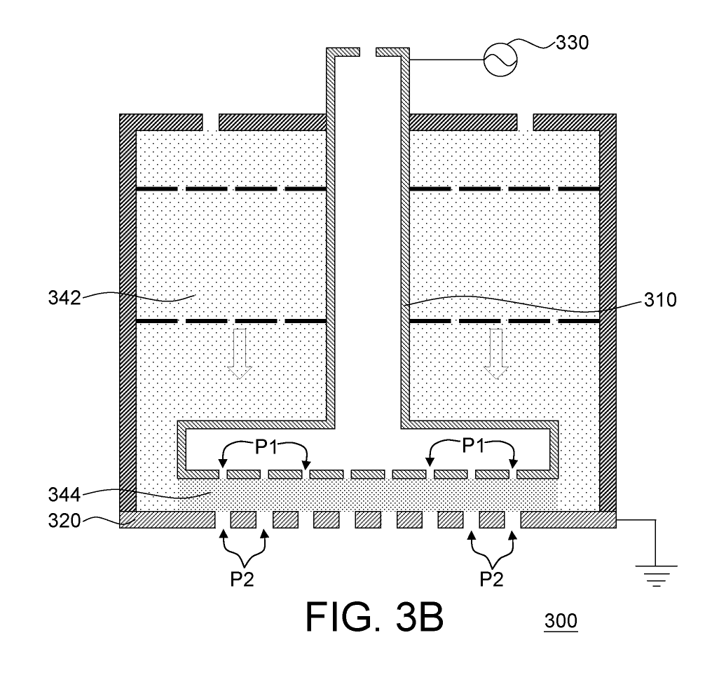

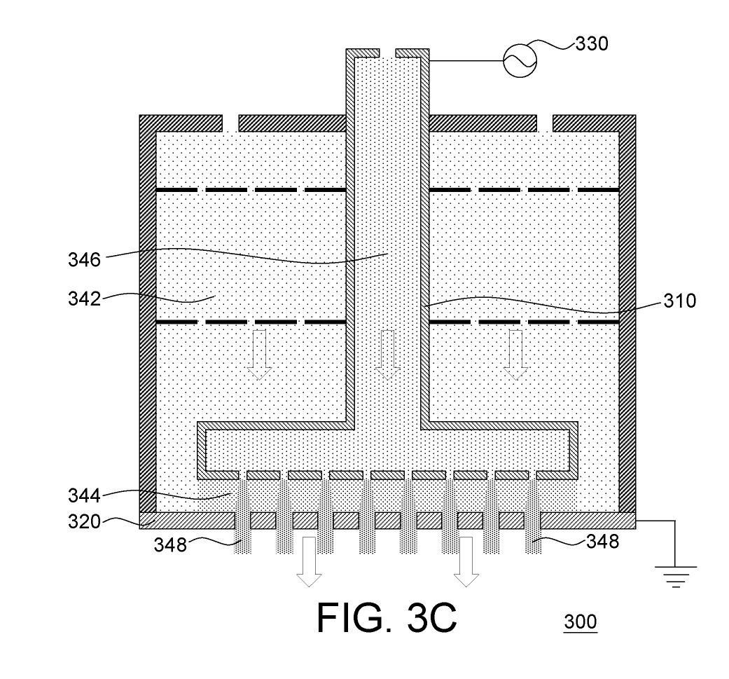

FIG. 3A is a cross-sectional view of an atmospheric-pressure plasma reactor according to one embodiment of the present invention. FIG. 3B and FIG. 3C are cross-sectional view showing the process of the atmospheric-pressure plasma reactor in FIG. 3A. Referring to FIG. 3A to FIG. 3C, the atmospheric-pressure plasma reactor 300 of the present invention comprises a first electrode 310, a second electrode 320 and a power generation unit 330. The first electrode 310 and second the electrode 320 respectively comprise a first opening P1 and a second opening P2 corresponding to each other. The first electrode 310 further comprises a gas-in space S4 communicating with the first opening P1. Moreover, the power generation unit 330 is coupled to the first electrode 310 to provide the first electrode 310 with AC power. The second electrode 320 is grounded.

When plasma gas 342 is introduced between the first electrode 310 and the second electrode 320, the plasma gas 342 is ionized into a first plasma source 344 by the change of electric field between the first electrode 310 and the second electrode 320. After the first plasma source 344 is uniformly distributed, the reactive gas 346 is introduced from the top of the first electrode 310 into the gas-in space S4 so that the reactive gas 346 moves downward and passes through the first opening P1. As a result, the reactive gas 346 reacts with the first plasma source 344 to form a second plasma source 348. The second plasma source 348 passes through the second opening P2 and performs the plasma process on the substrate (not shown).

By proper design of the first opening P1 and the second opening P2, the reactive gas 346 and the second plasma source 348 can be uniformly distributed. More particularly, since both the first plasma source 344 and the reactive gas 346 are uniformly distributed, the resulted second plasma source 348 is uniformly distributed so as to enhance the quality of the plasma process. As a result, the deposited thin film exhibits uniform thickness and the transparency, adhesion and hardness thereof are enhanced. Moreover, in the atmospheric-pressure plasma reactor 300 of the present invention, the power generation unit 330 only requires a voltage of 200 to 300 volts to ionize the plasma gas 342, which improves the security of the atmospheric-pressure plasma reactor 300. Accordingly, the frequency of the AC power is increased to a range between 100 KHz and 100 MHz. In the present embodiment, the AC power is radio-frequency (RF) power, with a frequency of 13.56 MHz.

Further referring to FIG. 3A to FIG. 3C, the atmospheric-pressure plasma reactor 300 further comprises a casing 350, which is connected to the second electrode 320 to form a containment space S5. Part of the first electrode 310 is disposed inside the containment space S5. The casing 350 comprises a third opening P3 so that the plasma gas 342 enters the containment space S5 from the third opening P3. The plasma gas 342 diffuses downward to be uniformly distributed inside the containment space S5.

It is noted that the present invention is characterized in that a uniform first plasma source 344 is generated between the first electrode 310 and the second electrode 320. Compared to the reactive gas 346 (or the second plasma source 348), the first plasma source 344 moves relatively slower. The first electrode 310 and the second electrode 320 comprise respectively a first opening P1 and a second opening P2 so that the reactive gas 346 moves downward to pass through the first opening P1 and form the second plasma source 348 passing through the second opening P2.

Accordingly, the shape of the casing 350 is only used to exemplify but not to limit the present invention. For example, the casing can be removed from the present invention so that the plasma gas is introduced directly from the first electrode and the second electrode. Those with ordinary skills in the art can make modifications without departing from the scope of the present invention.

In the present embodiment, to further uniformize the plasma gas 342, the atmospheric-pressure plasma reactor 300 further comprises two diffusing plates 362 in the containment space S5. Each of the diffusing plates 362 comprises a plurality of diffusing holes P4 so that the plasma gas 342 can be further uniformly distributed during downward diffusion. Certainly, the atmospheric-pressure plasma reactor 300 further comprises a diffusing plate 364 in the gas-in space S4 so that the reactive gas 342 further moves downward uniformly. Those with ordinary skills in the art can easily understand, and thus the detailed description thereof is not presented here.

Moreover, the plasma gas 342 can be helium, oxygen, nitrogen, argon or any other proper gas to be ionized into the first plasma source 344. For etching, the reactive gas 346 can be helium, oxygen, nitrogen, argon or combination thereof. For film growth or other process, the reactive gas 346 can be carbon fluoride, a siloxane compound or any other proper gas. The siloxane compound comprises tetraethoxysilane (TEOS), tetramethylcyclotetrasiloxane (TMCTS), tetramethyldisiloxane (TMDSO), hexamethyldisiloxane (HMDSO) or hexamethyldisilazane (HMDSN), etc. Furthermore, the first electrode 310 comprises a copper alloy. The second electrode 320 comprises stainless steel. However, the present invention is not restricted to the materials used for the first electrode 310 and the second electrode 320. The materials for the first electrode 310 and the second electrode 320 can also be aluminum, copper, aluminum alloy, copper alloy or any other proper metal conductor or metal alloy. Furthermore, the second electrode 320 and the casing 350 can be formed as one by punching.

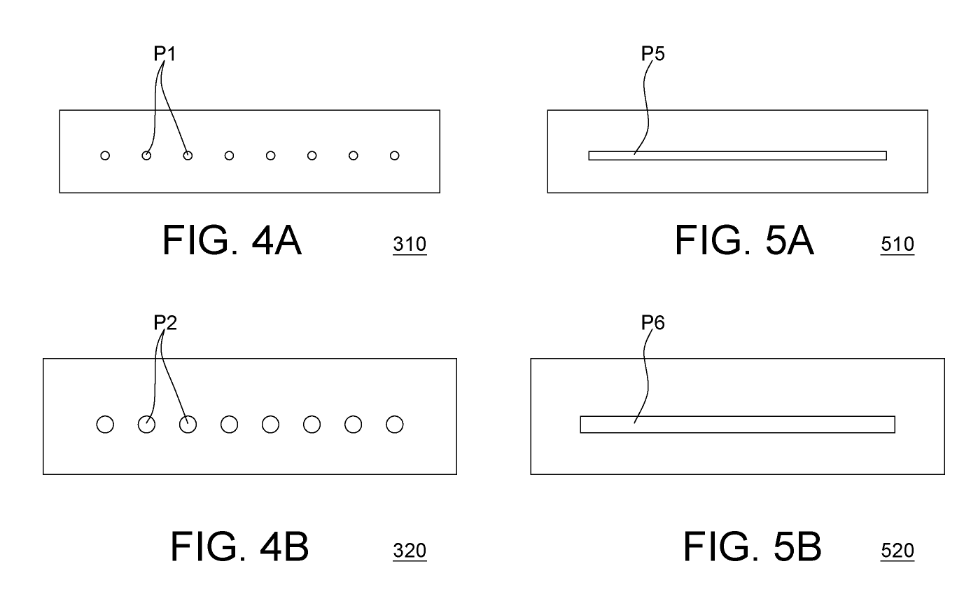

FIG. 4A and FIG. 4B are top views of a first electrode and a second electrode of the atmospheric-pressure plasma reactor in FIG. 3A, respectively. Referring to FIG. 4A and FIG. 4B, in the present embodiment, the first opening P1 and the second opening P2 are hole-shaped. In other words, the first opening P1 comprises a plurality of first holes, and the second opening P2 comprises a plurality of second holes corresponding to the first holes. The diameter of the second holes is larger than that of the first holes. Moreover, the diameter of the first holes and the diameter of the second holes cannot be too large. Instead, they have to be designed according to the distance between the first electrode 310 and the second electrode 320. Experimentally, the distance between the first electrode 310 and the second electrode 320 is within the range from 1 to 10 mm. The plasma process of the present invention provides better film quality and etching quality when the diameters of the first holes and the second holes are within the range from 1 to 5 mm.

However, the shape of the first opening P1 and the second opening P2 is not restricted to holes. FIG. 5A and FIG. 5B are top views of a first electrode and a second electrode of an atmospheric-pressure plasma reactor according to another embodiment of the present invention, respectively. Referring to FIG. 5A and FIG. 5B, in the present embodiment, the first electrode 510 and the second electrode 520 comprise, respectively, a first opening P5 and a second opening P6. The first opening P5 and the second opening P6 are both slot-shaped. For example, the first opening P5 and the second opening P6 are slit-shaped slots. In other words, the first opening P5 comprises a first slot, and the second opening P6 comprises a second slot corresponding to the first slot. The width of the second slot is larger than that of the first slot.

Accordingly, in the present embodiment, the number of the first slot and the number of the second slot are both one. However, the present invention is not restricted to the number of the first slot and the second slot. Moreover, the width of the first slot and the second slot is within a range from 1 to 5 mm. Furthermore, in the present invention the hole-shaped first opening can be used with the slot-shaped second opening, which is readily understood by those with ordinary skills in the art and thus description thereof is not presented here. Moreover, the present invention is not restricted to the shape of the first opening and the second opening, which can be designed according to actual needs. For example, the first opening and the second opening are both hole-shaped. Alternatively, the first opening is hole-shaped and the second opening is a slit-shaped slot. Alternatively, the first opening and the second opening are both slit-shaped slots.

Referring to FIG. 3A FIG. 3C again, the diffusing plate 362 and the diffusing plate 364 are used to further uniformize the plasma gas 342 and the reactive gas 346. Especially after the reactive gas 346 passes through the diffusing plate 364, the reactive gas 346 is prevented from concentrating in the central portion. However, the present invention is not restricted to disposing the diffusing plate 362 and the diffusing plate 364. For example, without disposing the diffusing plate 364, the diameter of the holes can be increased radially from the central portion so as to achieve a uniformly distributed second plasma source 348. Certainly, with the opening being a slot, the width of the slot can be increased radially from the central portion so as to achieve the same purpose.

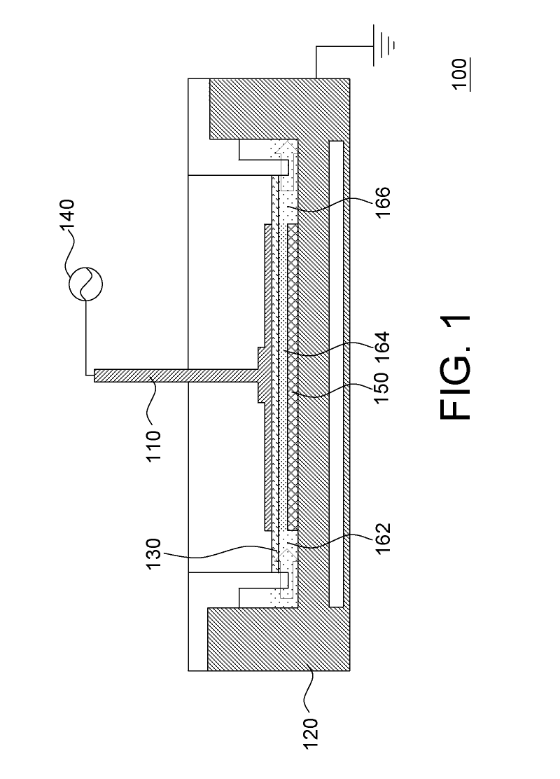

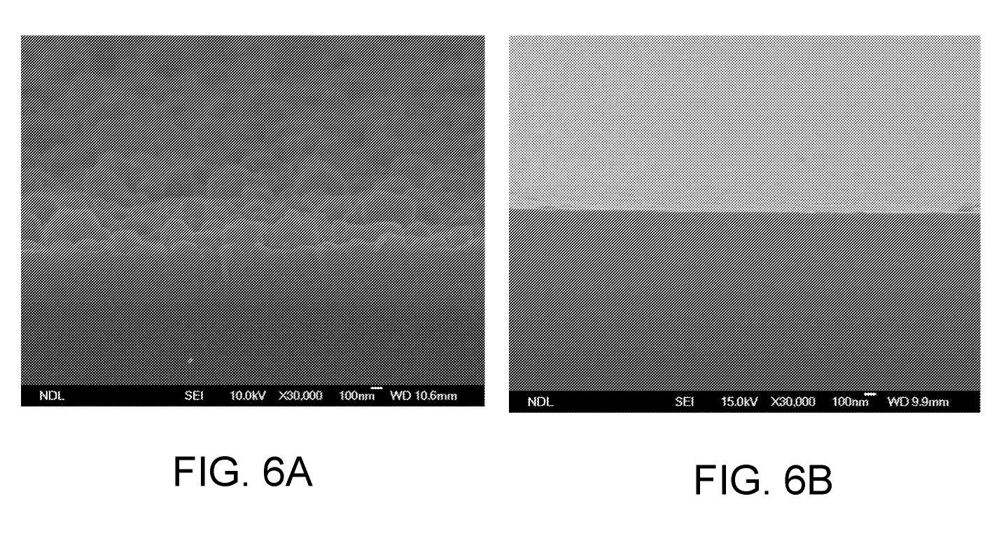

FIG. 6A and FIG. 6B are SEM pictures showing silicon dioxide thin films formed by a conventional atmospheric-pressure plasma reactor and an atmospheric-pressure plasma reactor of the present invention, respectively. The atmospheric-pressure plasma reactor in FIG. 1 is used in the prior art, while the atmospheric-pressure plasma reactor comprising the first electrode and the second electrode in FIGS. 5A and 5B is used in the present invention. Referring to FIG. 6A and FIG. 6B, the surface of the silicon dioxide thin film in FIG. 6A is rough with roughness of about 79.822 nm, while the surface of the silicon dioxide thin film in FIG. 6B is very smooth with roughness of about 2.003 nm. Therefore, the atmospheric-pressure plasma reactor in the present invention improves the surface uniformity. Moreover, the transparency as well as adhesion of the silicon dioxide thin film in FIG. 6B is much better than that in FIG. 6A.

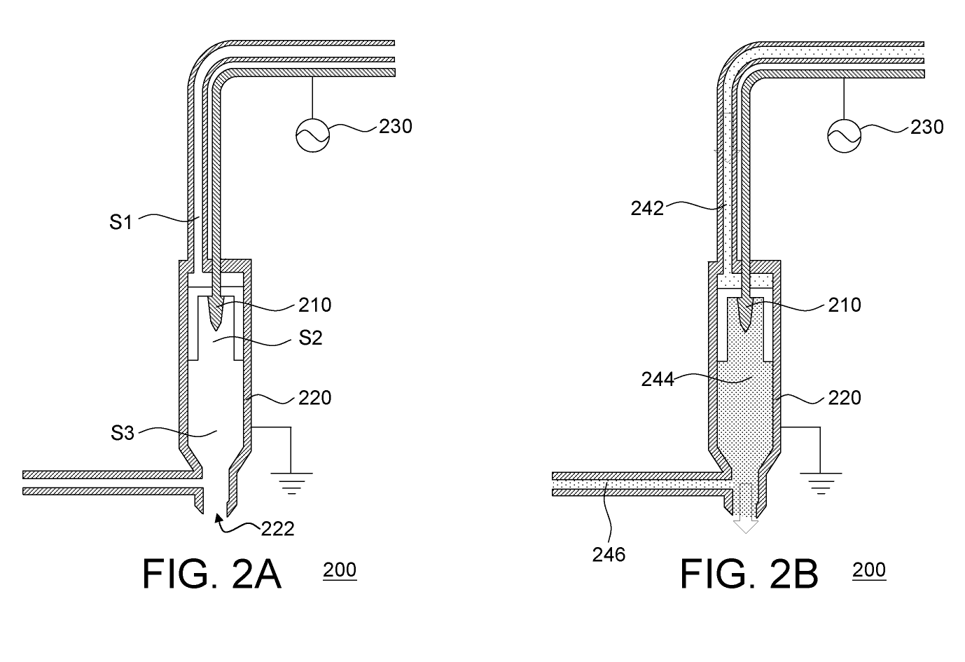

It is noted that, compared to the plasma source from the atmospheric-pressure plasma reactor in FIG. 2A which is injected from a single point region, the plasma source from the atmospheric-pressure plasma reactor of the present invention is injected from a linear region (planar injection can also be achieved by planarly distributing the first and the second openings). Therefore, in the present invention, the efficiency of plasma process can be improved. Furthermore, the atmospheric-pressure plasma reactor of the present invention can provide plasma processes on a variety of substrates without any restriction, which leads to lowered manufacturing cost.

According to the above discussion, it is apparent that the present invention discloses an atmospheric-pressure plasma reactor capable of forming a high-uniformity thin film on the substrate. Moreover, in the present invention, the voltage of the AC power is reduced to 200 to 300 volts for the plasma process so as to enhance the overall security of the atmospheric-pressure plasma reactor.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An atmospheric-pressure plasma reactor, comprising:
a first electrode comprising a gas-in space disposed therein and a first opening communicating with the gas-in space;
a second electrode comprising a second opening corresponding to the first opening; and
a power generation unit coupled to the first electrode to provide the first electrode with AC power, while the second electrode is grounded.

2. The atmospheric-pressure plasma reactor as recited in claim 1, wherein the first opening comprises a plurality of first holes, and the second opening comprises a plurality of second holes corresponding to the first holes respectively.

3. The atmospheric-pressure plasma reactor as recited in claim 2, wherein the diameter of the second holes is larger than that of the corresponding first holes respectively.

4. The atmospheric-pressure plasma reactor as recited in claim 1, wherein the first opening comprises a plurality of first holes, and the second opening comprises a second slot corresponding to the first holes.

5. The atmospheric-pressure plasma reactor as recited in claim 4, wherein the width of the second slot is larger than the diameter of the first holes.

6. The atmospheric-pressure plasma reactor as recited in claim 1, wherein the first opening comprises a first slot, and the second opening comprises a second slot corresponding to the first slot.

7. The atmospheric-pressure plasma reactor as recited in claim 6, wherein the width of the second slot is larger than that of the first slot.

8. The atmospheric-pressure plasma reactor as recited in claim 7, wherein the length of the second slot is larger than that of the first slot.

9. The atmospheric-pressure plasma reactor as recited in claim 1, wherein the frequency of the AC power is within a range from 100 KHz to 100 MHz.

10. The atmospheric-pressure plasma reactor as recited in claim 9, wherein the AC power is radio-frequency (RF) power.

11. The atmospheric-pressure plasma reactor as recited in claim 1, further comprising a casing connected to the second electrode to form a containment space, wherein the first electrode is disposed inside the containment space and the casing comprises a third opening communicating with the containment space.

12. The atmospheric-pressure plasma reactor as recited in claim 11, further comprising a plasma gas, entering the containment space through the third opening to generate a first plasma source between the first electrode and the second electrode.

13. The atmospheric-pressure plasma reactor as recited in claim 12, wherein the plasma gas comprises helium, oxygen, nitrogen, argon or combination thereof.

14. The atmospheric-pressure plasma reactor as recited in claim 12, further comprising a reactive gas, passing through the first opening from the gas-in space to react with the first plasma source to generate a second plasma source that passes through the second opening.

15. The atmospheric-pressure plasma reactor as recited in claim 14, wherein the reactive gas comprises a siloxane compound.

16. The atmospheric-pressure plasma reactor as recited in claim 15, wherein the siloxane compound comprises tetraethoxysilane (TEOS), tetramethylcyclotetrasiloxane (TMCTS), tetramethyldisiloxane (TMDSO), hexamethyldisiloxane (HMDSO) or hexamethyldisilazane (HMDSN).

17. The atmospheric-pressure plasma reactor as recited in claim 14, wherein the reactive gas comprises helium, oxygen, nitrogen, argon or combination thereof.

18. The atmospheric-pressure plasma reactor as recited in claim 14, wherein the reactive gas comprises carbon fluoride.

19. The atmospheric-pressure plasma reactor as recited in claim 11, further comprising a diffusing plate disposed inside the containment space, the diffusing plate comprising a plurality of diffusing holes.

20. The atmospheric-pressure plasma reactor as recited in claim 1, further comprising a diffusing plate disposed inside the gas-in space, the diffusing plate comprising a plurality of diffusing holes.

21. The atmospheric-pressure plasma reactor as recited in claim 1, wherein the first electrode comprises a metal conductor.

22. The atmospheric-pressure plasma reactor as recited in claim 1, wherein the second electrode comprises a metal conductor.

23. The atmospheric-pressure plasma reactor as recited in claim 11, wherein the casing and the second electrode are formed as one.
